(19) United States
(12) Patent Application Publication
(10) Pub. No.: US 2009/0061871 A1
(43) Pub. Date: Mar. 5, 2009

(54) BASE STATION NEIGHBOR LIST OPTIMIZATION

(75) Inventors: Joel L. Gross, Gilbert, AZ (US); Jonathan H. Gross, Gilbert, AZ (US); Thomas J. Schlangen, Gilbert, AZ (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/846,611

(22) Filed: Aug. 29, 2007

(51) Int. Cl. H04Q 7/20

(52) U.S. Cl. 455/436

(57) ABSTRACT

A method, information processing system, and wireless communication system for optimizing neighbor lists. A set of target communication sectors (240, 242) are identified within a given distance threshold from at least one of the base station (106) and a wireless device (134) currently registered with the base station (106). At least one target communication sector (240) is randomly selected from the set of communication sectors (240, 242). An identifier associated with the at least one randomly selected target communication sector (240) is inserted into a base station neighbor list (138). The base station neighbor list (138) is prioritized based on a set of call detail records associated with the at least one randomly selected target communication sector (240).

### FIELD OF THE INVENTION

The present invention generally relates to the field of wireless communications, and more particularly relates to optimizing base station neighbor lists.

### BACKGROUND OF THE INVENTION

Wireless communication systems are comprised of a large number of base stations or coverage areas. One problem with current wireless communication systems and with CDMA networks in particular is base station neighbor list optimization. A base station neighbor list comprises the identity and various other parameters of base stations within a network. These lists can be general and directed towards the entire network or be directed at specific base stations. For example, one base station can have a base station neighbor list that is different from another base station.

Current wireless communication networks do not provide an automated way to dynamically learn/determine the most optimized neighbor list associations. Stated differently, current systems only provide manual mechanisms to determine optimized neighbor list associations. Existing solutions are discrete and require significant man-hours of analysis and manual reconfiguration in order to optimize the network. Furthermore, these solutions do not account for seasonal foliage or terrain dynamics, building construction, and the like.

Therefore a need exists to overcome the problems with the prior art as discussed above.

### SUMMARY OF THE INVENTION

A method for optimizing base station neighbor lists is disclosed. The method comprises identifying a set of target communication sectors within a given distance threshold from at least one of the base station and a wireless device currently registered with the base station. At least one target communication sector is randomly selected from the set of communication sectors. An identifier associated with the at least one randomly selected target communication sector is inserted into a base station neighbor list. The base station neighbor list is prioritized based on a set of call detail records associated with the at least one randomly selected target communication sector.

In another embodiment an information processing system communicatively coupled to at least one base station in a wireless communication system for optimizing neighbor lists is disclosed. The information processing system comprises a memory and a processor that is communicatively coupled to the memory. The information processing system also includes an element manager that is communicatively coupled to the memory and the processor. The element manager is adapted to identify a set of target communication sectors within a given distance threshold from at least one of the base station and a wireless device currently registered with the base station. At least one target communication sector is randomly selected from the set of communication sectors. An identifier associated with the at least one randomly selected target communication sector is inserted into a base station neighbor list. The base station neighbor list is prioritized based on a set of call detail records associated with the at least one randomly selected target communication sector.

In yet another embodiment a wireless communication system is disclosed. The wireless communication system includes a plurality of base stations and a plurality of wireless communication devices. Each wireless communication device is communicatively coupled to at least one base station. The wireless communication system further includes an information processing system that is communicatively coupled to at least one base station. The information processing system also includes an element manager that is communicatively coupled to the memory and the processor. The element manager is adapted to identify a set of target communication sectors within a given distance threshold from at least one of the base station and a wireless device currently registered with the base station. At least one target communication sector is randomly selected from the set of communication sectors. An identifier associated with the at least one randomly selected target communication sector is inserted into a base station neighbor list. The base station neighbor list is prioritized based on a set of call detail records associated with the at least one randomly selected target communication sector.

An advantage of the foregoing embodiments of the present invention is that neighbor list information can be dynamically configured and optimized automatically. An element manager can dynamically learn what the most beneficial neighbor associations (e.g., targets for the source coverage sectors) are from examination of Call Detail Records. New associations can be periodically injected into neighbor lists and examined to further optimize the neighbor lists automatically without operator or third party intervention. The present invention also accounts for seasonal foliage or other temporary obstructions by injecting a new association periodically into the candidate neighbor list. These newly injected associations can then be evaluated against established associations.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a wireless communication system according to an embodiment of the present invention;

FIG. 2 illustrates one example of a source communication sector and target communication sectors according to an embodiment of the present invention;

FIG. 3 is a block diagram illustrating a detailed view of a wireless device according to an embodiment of the present invention;

FIG. 4 is a block diagram illustrating a detailed view of an information processing system according to an embodiment of the present invention;

FIG. 5 is an operational flow diagram illustrating an overall process of the present invention according to an embodiment of the present invention;

FIG. 6 is an operational flow diagram illustrating a more detailed process of evaluating target communication sectors that have been randomly inserted into a base station neighbor list according to an embodiment of the present invention; and

FIG. 7 is an operational flow diagram illustrating a more detailed process of generating an optimized base station neighbor list according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term “wireless device” is intended to broadly cover many different types of devices that can wirelessly receive signals, and optionally can wirelessly transmit signals, and may also operate in a wireless communication system. For example, and not for any limitation, a wireless communication device can include any one or a combination of the following: a two-way radio, a cellular telephone, a mobile phone, a smartphone, a two-way pager, a wireless messaging device, a laptop/computer, automotive gateway, residential gateway, and the like.

Wireless Communication System

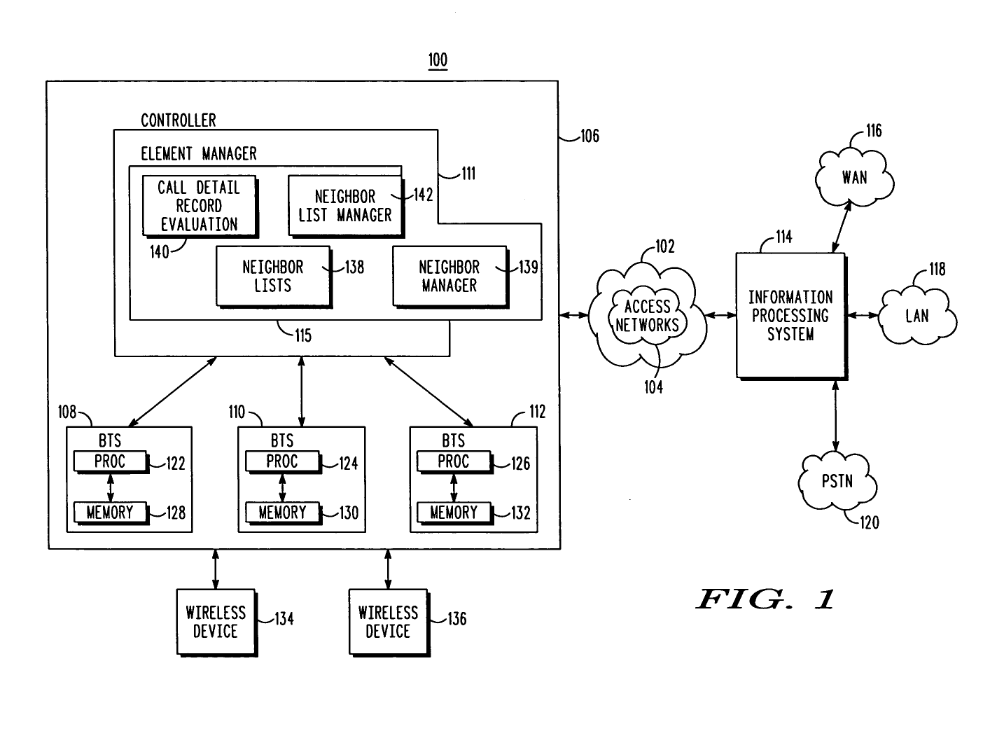

According to an embodiment of the present invention as shown in FIG. 1 a wireless communication system 100 is illustrated. FIG. 1 shows a wireless communication network 102 comprising one or more access networks 104 such as a packet data network and/or a circuit services network. Throughout the following discussion, the communication standard of the wireless communication network 102 is referred to as Code Division Multiple Access (“CDMA”). However, the present invention is not limed to CDMA. For example, other communication standards such as Time Division Multiple Access (“TDMA”), Global System for Mobile Communications (“GSM”), General Packet Radio Service (“GPRS”), Frequency Division Multiple Access (“FDMA”), other IEEE 802.16 standards, Orthogonal Frequency Division Multiplexing (“OFDM”), Orthogonal Frequency Division Multiple Access (“OFDMA”), LTE, UMB, Wireless LAN (“WLAN”), WiMax or the like are also applicable to the present invention. Other applicable communications standards include those used for Public Safety Communication Networks including Project 25 (“P25”) or TErrestrial TRunked rAdio (“TETRA”).

In one embodiment, the packet data network is an IP or SIP based connectivity network, which provides data connections at much higher transfer rates than a traditional circuit services network. A packet data network can comprise an Evolution Data Only (“EV-DO”) network, a General Packet Radio Service (“GPRS”) network, a Universal Mobile Telecommunications System (“UMTS”) network, an 802.11 network, an 802.16 (WiMax) network, Ethernet connectivity, dial-up modem connectivity, or the like. A circuit services network provides, among other things, voice services to the wireless device 102. It should be noted that access networks also include additional components (not shown) such as controllers, transport/interconnect gear, network management modules, and the like that should be known to those of ordinary skill in the art.

The wireless communication system 100 also includes a Base Station Subsystem (“BSS”) 106 communicatively coupled to the wireless communication network 102. The BSS 106 comprises multiple Base Transceiver Stations (“BTSs” or “base stations”) 108, 110, 112. Each of the base stations 108, 110, 112 is communicatively coupled to a controller 111, such as a Base Station Controller (“BSC”) or a Central Base Station Controller (“CBSC”). An information processing system 114 such as a mobile switching center (“MSC”) communicatively couples the BSS 106 to one or more external networks such as a Wide Area Network (“WAN”) 116, a Local Area Network (“LAN”) 118, and a Public Switched Telephone Network (“PSTN”) 120.

Each of the multiple base stations 108, 110, 112 include a respective processor 122, 124, 126 such as one or more microprocessors, microcontrollers, digital signal processors (“DSPs”), combinations thereof, or such other devices known to those having ordinary skill in the art. Each of the multiple base stations 108, 110, 112 further includes respective one or more memory devices 128, 130, 132 respectively associated with the processor 122, 124, 126 such as random access memory (“RAM”), dynamic random access memory (“DRAM”), and/or read only memory (“ROM”), or equivalents thereof, that store data and programs that may be executed by the processor.

The wireless communication system 100 supports any number of wireless devices 134, 136, which can be single mode or multi-mode devices. Multi-mode devices are capable of communicating over multiple access networks with varying technologies. For example, a multi-mode device can communicate over the access networks 104 using various services such as Push-To-Talk (“PTT”), Push-To-Talk Over Cellular (“PoC”), multimedia messaging, web browsing, VoIP, multimedia streaming, and the like.

In one embodiment, the controller 111 includes an element manager 115 for automatically and dynamically optimizing base station neighbor lists 138 used by wireless devices 134, 136 for hand-off procedures. The element manager 115 includes a call detail record evaluator 140, a neighbor list manager 142, and neighbor lists 130. Each of these components and the neighbor list optimization process are discussed in greater detail below. It should be noted that the element manager 115 and its components are not limited to residing in the controller 111. For example, these elements can also reside in a site controller (not shown) residing at each base station 108, 110, 112 or a third party information processing system(s) (i.e., an information processing system that is not operated by the service provider).

Neighborhood List Optimization

As discussed above, the element manager 115 automatically and dynamically optimizes base station neighbor lists 138 that are used by wireless devices 124, 136 during hand-off procedures. A hand-off procedure, in one embodiment, is when a wireless device 134, 136 migrates from a current base station to a new base station or from a current sector to a new sector. The wireless device 134, 136 receives a base station neighbor list 138 from its current base station and analyzes the list 138 to determine a new base station and sector to be the target of the hand-off. For example, the neighbor lists 138 can include information such as base station and sector IDs, performance data, available bandwidth data, and the like. The neighbor lists 138 are automatically and dynamically updated to ensure that the wireless device 134, 136 receives an optimized list a neighbor list 138 that has been optimized. These updates can be performed periodically and to account for seasonal changes, terrain obstructions, general mobility patterns, network expansion, and the like, as discussed in greater detail below.

Therefore, embodiments of the present invention are advantageous over conventional neighbor list updating systems because automatic and dynamic optimization can be performed on the neighbor lists 138. Conventional systems, as discussed above, are generally point optimized and do not account for seasonal foliage or other temporary obstructions. Embodiments of the present invention, on the other hand, optimally configures neighbor list information for sectors by analyzing call detail records and injecting new associations within the list. These new associations are then examined to automatically and dynamically update the neighbor lists 138 without operator or third party manipulation.

In one embodiment, the element manager 115 manages a list of all possible sectors within the wireless communication system 100 that are within a given distance from a source sector (i.e., the sector where a wireless device 134, 136 is currently located). In one embodiment, the list of all possible sectors is manually provisioned by the operator and stored in a database. However, in another embodiment, all network elements of the system are automatically discovered, and all locations are derived with GPS. Therefore, the list of possible sectors can reside in a database, which is populated by the methods discussed above or by any other methods. In other words, the present invention is not limited to these two methods of providing the list of possible sectors to the element manager 115.

It should be noted that the following optimization process is performed automatically and dynamically. For example, if the element manager 115 determines that a period of time has elapsed since a prior optimization, the optimization process is initiated. Alternatively, the optimization process can be performed based on seasonal changes or detected changes in the system configuration (detection of network expansion). For example, the element manager 115 can determine that the current season is Fall and that the optimization process is to be performed to compensate for the lack of foliage on trees. Furthermore, the element manager 115 can determine that changes in the network have occurred such as the addition/removal of base stations. Therefore, the element manager 115 performs the optimization process to compensate for these changes as well. As can be seen, the embodiments of the present invention do not require manual reconfiguration to optimize network neighbor lists.

The optimization process starts by the element manager 115 selecting a random candidate hand-off target sector for association with the neighbor list 138. A candidate hand-off target sector, in one embodiment, is a sector within the given distance threshold from the source sector that a wireless device 134, 136 can potentially realize a successful hand-off. The neighbor list 138, as discussed above, is a list of sectors that neighbor a current sector where a wireless device 134, 136 currently resides and are within the given distance threshold. The neighboring sectors can be associated with a current base station associated with the wireless device 134, 136 (i.e., the same base station providing the source sector) or with a neighboring base station.

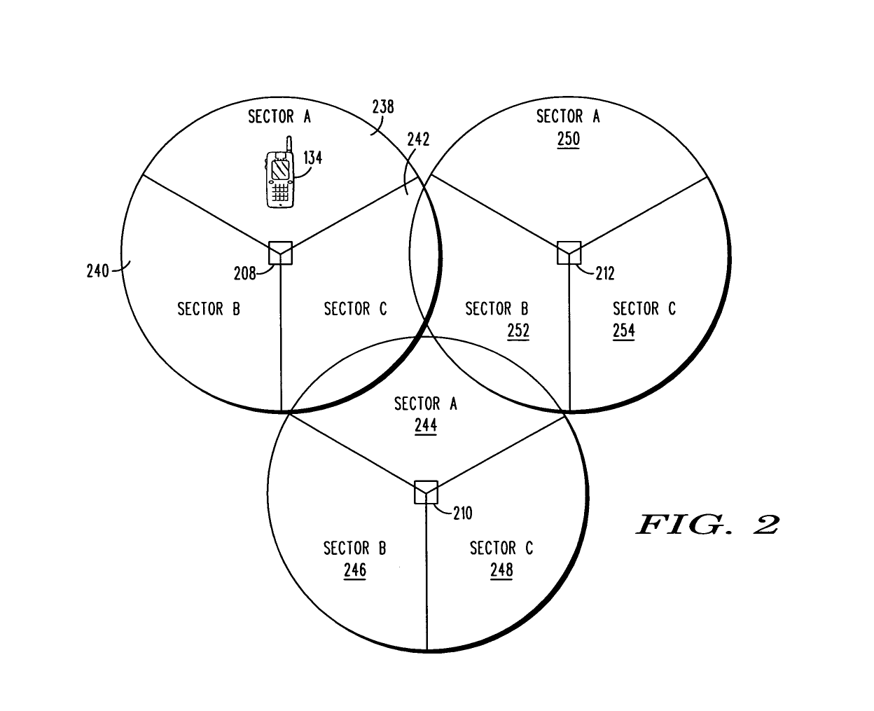

For example, FIG. 2 shows an example of base stations and sectors. In particular, FIG. 2 shows three base stations 208, 210, 212. Each base station 208, 210, 212 includes multiple sectors such as Sector A 238, Sector B 240, and Sector C 242. In the example of FIG. 2, the wireless device 134 is in Sector A 238, the source sector, provided by Base Station A 238. As can be seen from FIG. 2, sectors or coverage areas of each base station 208, 210, 212 can overlap. The other sectors 240, 242 of Base Station A 208 as well as the sectors of Base Station B 210 and Base Station C 212 can be designated as neighbor sectors of the source sector 238 if they are within a given distance threshold from the source sector 238. For example, if Sectors B and C 240, 242 of Base Station A 208 and Sectors A and B 244, 246 of Base Stations A and B 210, 212 are within the given distance threshold to the source sector, Sector A 238, the element manager 115 designates these sectors as neighbor sectors. In the example of FIG. 2, Sector C 248, 254 of both Base Station B 210 and Base Station C 212 are outside the given distance threshold.

Returning back to FIG. 1, the element manager 115 selects a random candidate hand-off target sector for association with the neighbor list 138 as follows. The neighbor manager 139 identifies all neighboring sectors to the source sector 238 that are within the given distance threshold. In one embodiment, the neighboring sectors can be identified by a list of all sectors within threshold distance. This list could be manually entered by the system operator of the list could be automatically generated using GPS location data.

The neighbor list manager 142 compares the current neighbor list 138 for the source sector 238 against the identified neighbor sectors. This comparison allows the element manager 115 to identify the neighbor sectors that are not currently in the neighbor list 138 associated with the source sector. One or more random neighbor sectors are selected from these identified sectors by the neighbor list manager 142. In one embodiment, this random selection can be weighted by various factors such as distance from the source sector (e.g. the wireless device 134 is more likely to select a closer neighbor as compared to a more distant neighbor), propagation characteristics (e.g., radio communication characteristics, viability of radio transmission and reception, and the like), antenna pointing directions, and the like. The randomly selected neighbor sector(s) is added, in one embodiment, to the bottom of the neighbor list 138.

Over a given period of time, the CDR record evaluator 140 of the element manager 115 evaluates the CDR records between the source sector and each of the neighboring sectors in the neighbor list 138 to determine the fitness of the source-target pairing. The CDR data, in one embodiment, can be uploaded to the element manager 115 by one or more computing devices in the system 100. This evaluation process, in one embodiment, is performed as follows. The element manager 115 receives system performance metric data such as CDR and PM (Performance Management) data from the source sector. Based on the received system performance metrics, the CDR record evaluator 140 determines the number of times each target sector within the neighbor list 138 is added to the active set of the call (e.g., number of hand-off attempts) and hand-off success rates (e.g., reverse link acquired on target sector).

The active set, in one embodiment, is the current list of sectors, which are actively supporting radio communication with the target device. Alternatively, the active set, in another embodiment, is the current list of sectors, which are actively supporting radio communication with the target device. Hand-off success rate, in one embodiment, is the number of hand-offs completed (e.g., target device reaches target channel) divided by the number of hand-offs attempted.

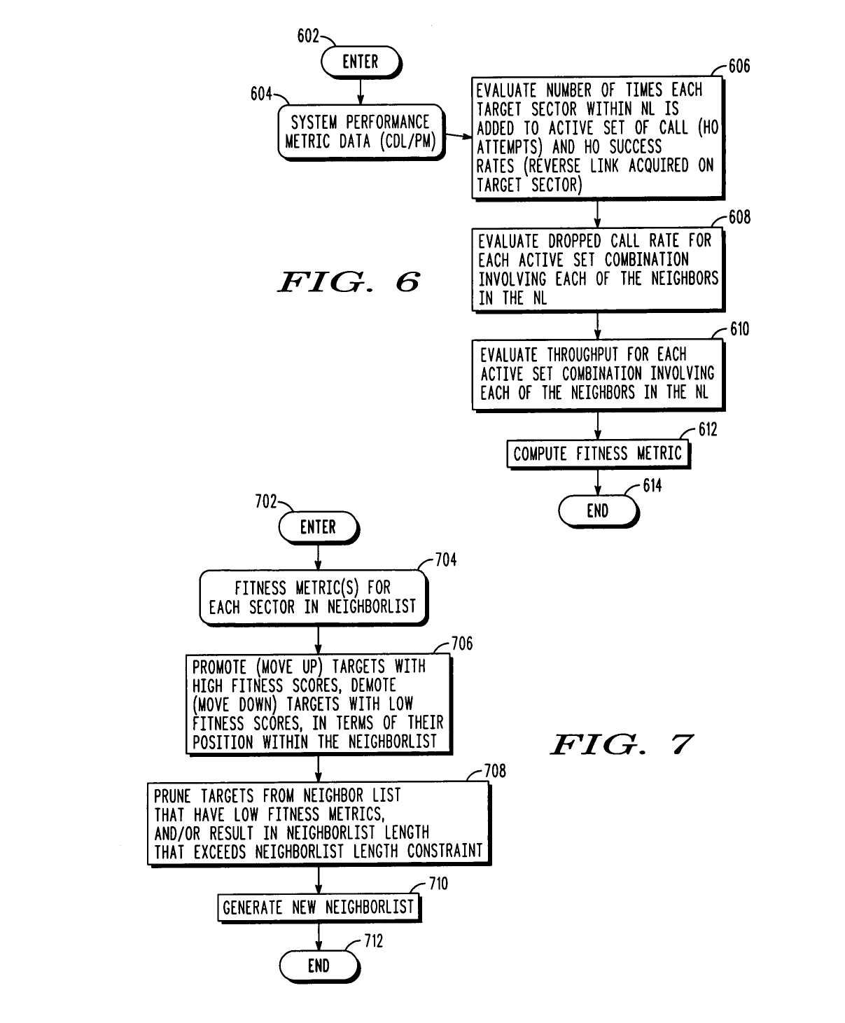

The CDR record evaluator 140 then evaluates the dropped call rate for each active set combination involving each of the neighbors in the neighbor list 138. The throughput for each active set combination involving each of the neighbors in the neighbor list 138 is evaluated. A fitness metric is determined by the element manager 115 based on one or more of the following: the number of times each sector in the neighbor list 138 was attempted to be added to the active set of call (i.e., attempted hand-off counts). In one embodiment, the higher the number the better the fitness metric is; successful hand-off rate to target sector, i.e., reverse link acquired after hand-off attempt to target sector. In one embodiment, the higher the success rate the better the fitness metric; and key performance metrics for this sector, and/or key performance metrics for this sector when in hand-off with other sectors (active set combinations). In one embodiment, the better the throughput, drop rates, and the like, the better the fitness metric. The fitness metric may be a weighted combination of any of these performance metrics. This notion of a weighted combination is discussed in greater detail with respect to FIG. 6. The actual fitness metric, in one embodiment, can be a weighted combination of any or all of these metrics (hand-off attempts, success rate, drop rate, throughput, and the like).

Once the CDR record evaluator 140 evaluates the source-target pairings in the neighbor list 138, the element manager 115 prioritizes a candidate target sector with respect to the other target sectors and sorts the target list based on the CDR success rates with the target. For example, the neighbor list 138 is reordered so that more successful target sectors are moved toward the top of the list and less successful target sectors are moved toward the bottom of the neighbor list 138.

This prioritization process, in one embodiment, can be performed as follows. The element manager 115 analyzes each of the fitness metrics associated with each target sector in the neighbor list 138. Target sectors with higher fitness scores are moved upward in the neighbor list 138 while target sectors with lower fitness scores are moved toward the bottom of the list. The element manager 115 removes target sectors from the neighbor list 138 that are within N bottom positions of the list 138. Alternatively, the targets that cause the list to be longer than a given length can also be removed from the list 138. The element manager 115 then generates a new list that reflects these changes. This new list is then transmitted to the base station of the source sector.

As shown, embodiments of the present invention periodically inject new and random target sectors into a sector neighbor list and evaluates system performance metrics associated with the source sector and the injected sector. This periodic and automatic optimization of the neighbor list allows for the neighbor list to be continually optimized without operator or third party intervention. The present invention is also advantageous because the neighbor list is optimized in light of seasonal changes, network changes, and the like.

Base Station

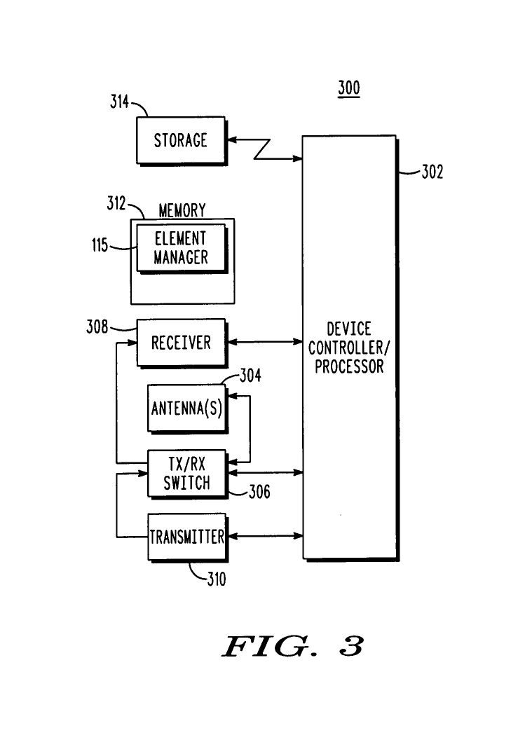

FIG. 3 is a block diagram illustrating a detailed view of a base station 300 according to an embodiment of the present invention. It is assumed that the reader is familiar with wireless communication devices. To simplify the present description, only that portion of a wireless communication device that is relevant to the present invention is discussed. The base station 300 operates under the control of a device controller/processor 302, which controls the sending and receiving of wireless communication signals. In receive mode, the device controller 302 electrically couples an antenna 304 through a transmit/receive switch 306 to a receiver 308. The receiver 308 decodes the received signals and provides those decoded signals to the device controller 302.

In transmit mode, the device controller 302 electrically couples the antenna 304, through the transmit/receive switch 306, to a transmitter 310. It should be noted that in one embodiment, the receiver 308 and the transmitter 310 are a dual mode receiver and a dual mode transmitter for receiving/transmitting over various access networks providing different air interface types. In another embodiment a separate receiver and transmitter is used for each of type of air interface.

The device controller 302 operates the transmitter and receiver according to instructions stored in the memory 312. These instructions include, for example, a neighbor cell measurement-scheduling algorithm. The memory 312 also includes the element manager 115 and its respective components as discussed above. The base station 300 also includes non-volatile storage memory 314 for storing, for example, an application waiting to be executed (not shown).

Information Processing System

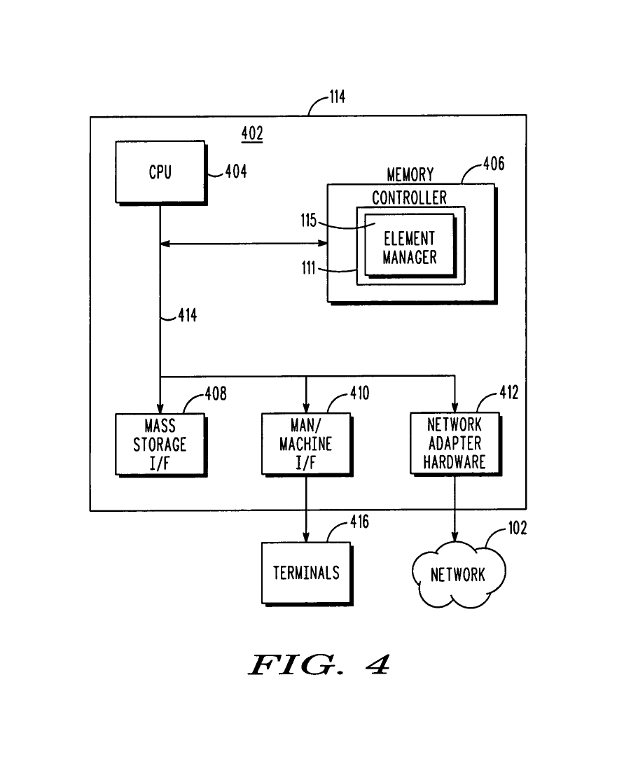

FIG. 4 is a block diagram illustrating a more detailed view of an information processing system 114. The information processing system 114 is based upon a suitably configured processing system adapted to implement one embodiment of the present invention. For example, a personal computer, workstation, or the like, may be used. The information processing system 114 includes a computer 402. The computer 402 has a CPU processor 404 that is connected to a main memory 406, a mass storage interface 408, a man-machine interface 410, and network adapter hardware 412. A system bus 414 interconnects these system components.

The main memory 406 can include the controller 111 and element manager 115 as discussed above with respect to the wireless device 106. Although illustrated as concurrently resident in the main memory 406, it is clear that respective components of the main memory 406 are not required to be completely resident in the main memory 406 at all times or even at the same time. Furthermore, one or more of these components can be implemented as hardware.

The mass storage interface 408 can store data on a hard-drive or media such as a CD or DVD. The man-machine interface 410 allows technicians, administrators, and the like, to directly connect to the information processing system 130 via one or more terminals 416. The network adapter hardware 412 is used to provide an interface to the communication network 102, and the like. Embodiments of the present invention are able to be adapted to work with any data communications links, including present day analog and/or digital techniques or via a future networking mechanism.

Overall Process of the Present Invention

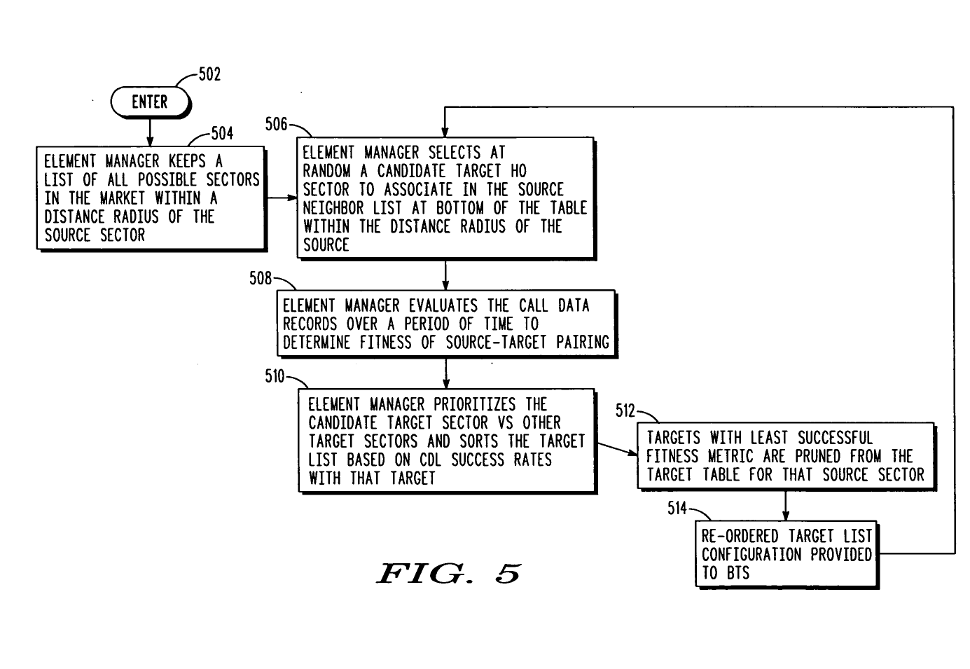

FIG. 5 is an operational flow diagram illustrating the overall process of the present invention. The operational flow diagram of FIG. 5 begins at step 502 and flows directly to step 504. The element manager 115, at step 504, maintains a list of all possible sectors in the market within a given radius of the source sector. The element manager 115, at step 506, selects a random candidate target hand-off sector for association within the neighbor list 138. In one embodiment, this randomly selected target is placed at the bottom of the neighbor list 138. This randomly selected target is also within the given radius of the source sector.

The call data records, at step 508, are evaluated over a period of time to determine the fitness of source-target pairings. This fitness metric can be based on a wireless device actually selecting a target sector for a hand-off; the hand-off success rate for attempted hand-offs into the target sector; and the percentage of successful hand-offs per hand-off attempts. The element manager 115, at step 510, prioritizes the candidate target sector vs. other target sectors. The element manager 115 also sorts the target list based on CDR success rates with that particular target. In one embodiment, the most successful targets are moved up in the list 138 and the least successful targets are moved down in the list 138. The element manager 115, at step 512, prunes the least successful targets from the target table for that source sector. The neighbor list 138 which has been prioritized, at step 514, is then provided to the source base station. The control flow returns to step 506.

Evaluation of Source-Target Pairings

FIG. 6 is an operational flow diagram illustrating a more detailed process for evaluating source-target pairings. The operational flow diagram of FIG. 6 begins at step 602 and flows directly to step 604. The element manager 115, at step 604, receives system performance metric data such as CDR and PM from the source sector. The element manager 115, at step 606, determines the number of times each target sector within the neighbor list 138 is added to the active set of call (e.g., hand-off attempts) and hand-off success rates (e.g., reverse link acquired on target sector).

The dropped call rate, at step 606, is evaluated for each active set combination involving each of the neighbors in the neighbor list 138. The element manager 115, at step 610, also evaluates the throughput for each active set combination involving each of the neighbors in the neighbor list 138. A fitness metric, at step 612, is determined by the element manager 115 based on one or more of the following factors. The number of times each sector in the neighbor list 138 was attempted to be added to the active set of call, i.e., attempted hand-off counts. In one embodiment, the higher the number the better the fitness metric is. A successful hand-off rate to target sector, i.e., reverse link acquired after hand-off attempt to target sector. In one embodiment, the higher the success rate the better the fitness metric. Key performance metrics for this sector, and/or key performance metrics for this sector when in hand-off with other sectors (active set combinations). In one embodiment, the better the throughput, drop rates, and the like, the better the fitness metric. The control flow then exits at step 614.

Optimized Neighbor List Generation

FIG. 7 is an operational flow diagram illustrating a more detailed process for generating an optimized neighbor list. The operational flow diagram of FIG. 7 begins at step 702 and flows directly to step 704. The element manager 115, at step 704, analyzes the fitness metric(s) for each sector in the neighbor list 138. The element manager 115, at step 706, promotes targets with higher fitness scores and demotes targets with lower fitness scores. The targets with scores lower than a given threshold, at step 708, are deleted from the neighbor list 138. The neighbor list 138, at step 710, is re-ordered based on the optimization. The control flow then exits at step 712.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with a base station, for optimizing neighbor lists, the method comprising:
identifying a set of target communication sectors within a given distance threshold from at least one of the base station and a wireless device currently registered with the base station;
randomly selecting at least one target communication sector from the set of communication sectors;
inserting an identifier associated with the at least one randomly selected target communication sector into a base station neighbor list; and
prioritizing the base station neighbor list based on a set of call detail records associated with the at least one randomly selected target communication sector.

2. The method of claim 1, wherein the inserting further comprises:
inserting the identifier associated with the at least one randomly selected target communication sector at the bottom of the base station neighbor list.

3. The method of claim 1, wherein the prioritizing further comprises:
prioritizing the base station neighbor list based on at least one metric value associated with the at least one randomly selected target communication sector, wherein an identifier associated with a randomly selected target communication sector comprising a higher metric than another randomly selected target communication sector is placed at a higher position in the base neighbor list.

4. The method of claim 1, wherein the prioritizing further comprises:
determining the at least one metric value based on at least one of:
a number of times that a wireless device selected the randomly selected target communication sector for hand-off procedure;
a success rate for attempted hand-offs into the randomly selected target communication sector;
a percentage of successful hand-offs per attempted hand-offs;
a throughput rate associated with the randomly selected target communication sector; and
a dropped call rate associated with the randomly selected target communication sector.

5. The method of claim 1, wherein the prioritizing further comprises:
removing identifiers associated with at least one of randomly selected target communication sectors comprising a metric value below a given threshold and randomly selected target communication sectors comprising a metric value above a given threshold.

6. The method of claim 1, wherein the prioritizing is performed automatically each time a given interval of time passes.

7. The method of claim 1, wherein the prioritizing is performed automatically in response to at least one of:
determining that seasonal changes have occurred;
determining that terrain within a given distance has changed; and
determining that a network configuration has changed.

8. An information processing system communicatively coupled to at least one base station in a wireless communication system for optimizing neighbor lists, the information processing system comprising:
a memory;
a processor communicatively coupled to the memory; and
an element manager communicatively coupled to the memory and the processor, wherein the element manager is adapted to:
identify a set of target communication sectors within a given distance threshold from at least one of the base station and a wireless device currently registered with the base station;
randomly select at least one target communication sector from the set of communication sectors;
insert an identifier associated with the at least one randomly selected target communication sector into a base station neighbor list; and
prioritize the base station neighbor list based on a set of call detail records associated with the at least one randomly selected target communication sector.

9. The information processing system of claim 8, wherein the inserting further comprises:
inserting the identifier associated with the at least one randomly selected target communication sector at the bottom of the base station neighbor list.

10. The information processing system of claim 8, wherein the prioritizing further comprises:
prioritizing the base station neighbor list based on at least one metric value associated with the at least one randomly selected target communication sector, wherein an identifier associated with a randomly selected target communication sector comprising a higher metric than another randomly selected target communication sector is placed at a higher position in the base neighbor list.

11. The information processing system of claim 8, wherein the prioritizing further comprises:
determining the at least one metric value based on at least one of:
a number of times that a wireless device selected the randomly selected target communication sector for hand-off procedure;
a success rate for attempted hand-offs into the randomly selected target communication sector;
a percentage of successful hand-offs per attempted hand-offs;
a throughput rate associated with the randomly selected target communication sector; and
a dropped call rate associated with the randomly selected target communication sector.

12. The information processing system of claim 8, wherein the prioritizing further comprises:
removing identifiers associated with at least one of randomly selected target communication sectors comprising a metric value below a given threshold; and
moving up in priority randomly selected target communication sectors comprising a metric value above a given threshold.

13. The information processing system of claim 8, wherein the prioritizing is performed automatically each time a given interval of time passes.

14. The information processing system of claim 8, wherein the prioritizing is performed automatically in response to at least one of:
determining that seasonal changes have occurred;
determining that terrain within a given distance has changed; and
determining that a network configuration has changed.

15. A wireless communication system comprising:
a plurality of base stations;
a plurality of wireless communication devices, wherein each wireless communication device is communicatively coupled to at least one base station; and
an information processing system communicatively coupled to at least one base station in, the information processing system comprising:
a memory;
a processor communicatively coupled to the memory; and
an element manager communicatively coupled to the memory and the processor, wherein the element manager is adapted to:
identify a set of target communication sectors within a given distance threshold from at least one of the base station and a wireless device currently registered with the base station;
randomly select at least one target communication sector from the set of communication sectors;
insert an identifier associated with the at least one randomly selected target communication sector into a base station neighbor list; and
prioritize the base station neighbor list based on a set of call detail records associated with the at least one randomly selected target communication sector.

16. The wireless communication system of claim 15, wherein the prioritizing further comprises:
prioritizing the base station neighbor list based on at least one metric value associated with the at least one randomly selected target communication sector, wherein an identifier associated with a randomly selected target communication sector comprising a higher metric than another randomly selected target communication sector is placed at a higher position in the base neighbor list.

17. The wireless communication system of claim 15, wherein the prioritizing further comprises:
determining the at least one metric value based on at least one of:
a number of times that a wireless device selected the randomly selected target communication sector for hand-off procedure;
a success rate for attempted hand-offs into the randomly selected target communication sector;
a percentage of successful hand-offs per attempted hand-offs;
a throughput rate associated with the randomly selected target communication sector; and
a dropped call rate associated with the randomly selected target communication sector.

18. The wireless communication system of claim 15, wherein the prioritizing further comprises:
removing identifiers associated with at least one of randomly selected target communication sectors comprising a metric value below a given threshold and randomly selected target communication sectors comprising a metric value above a given threshold.

19. The wireless communication system of claim 15, wherein the prioritizing is performed automatically each time a given interval of time passes.

20. The wireless communication system of claim 15, wherein the prioritizing is performed automatically in response to at least one of:
determining that seasonal changes have occurred;
determining that terrain within a given distance has changed; and
determining that a network configuration has changed.
